(19) United States
(12) Patent Application Publication
(10) Pub. No.: US 2003/0115179 A1
(43) Pub. Date: Jun. 19, 2003

(54) Configuration management for group policies

(76) Inventors: Senthil Prabakaran, Norwood, MA (US); Dilip Radharishnan, North Quincy, MA (US); Vladimir Kazachkov, Chestnut Hill, MA (US)

Correspondence Address: EMILY A. BERGER, Fish & Richardson P.C., 225 Franklin Street, Boston, MA, 02110-2804, US

(21) Appl. No.: 10/286,050

(22) Filed: Nov. 1, 2002

Related U.S. Application Data
(60) Provisional application No. 60/334,744, filed on Nov. 1, 2001.

(51) Int. Cl. G06F 7/00

(52) U.S. Cl. 707/1

(57) ABSTRACT

A method of analyzing group policies in an information management system is provided. The method includes monitoring information obtained for a policy repository console, logging the monitored information into a policy editor, and analyzing the monitored information via a repository administration.

### TECHNICAL FIELD

This invention relates to configuration management for group policies.

### BACKGROUND

Policies are used to control the operation and functionality of computers and peripheral hardware devices. Policies are a set of enforceable parameters that control the operation and functionality of computers and peripheral hardware devices used by each of the computers (e.g., printers). Policies are utilized in both distributed computing environments (e.g., local area networks or wide area networks) and stand-alone personal computers. In a distributed computing environment, policies are generated and stored in a central computer system (e.g., a server) and downloaded to the individual computers linked to the network (e.g., workstations) each time a user logs on to a computer in the network. In a stand-alone personal computer, policies are generated and stored locally on the personal computer.

Primarily, policies are used to ease the administration of a number of personal, peripheral hardware devices, and users located in a distributed computing environment. In addition to providing a more manageable, uniform environment, policies can: 1) limit access to critical system files; 2) control access to certain software applications; 3) control access to hardware resources located on a network; 4) define what can and cannot be installed on a personal computer; and 5) permit or deny access to the personal computer or peripheral hardware devices based on appropriate security authentication.

Managing personal computers (or a network of computers) with policies, minimizes the support costs attendant with the ownership of a personal computer. Support costs include direct support provided by dedicated personnel (e.g., network administrators) as well as indirect support provided by the user or other personnel. In addition, down-time associated with inoperable computers is a major contributor to the total cost of ownership (TCO) of a computer. Moreover, as computing environments increase in capability and complexity, the support burden also increases.

Enterprises need to have control over desktop and server configurations in order to reduce TCO. The TCO is the amount of money it takes to purchase, run, and maintain a piece of equipment. In terms of computers within organizations, TCO includes the original price of the hardware and software, as well as the salaries paid to Information Technology (IT) personnel for setting up and configuring the servers and clients. However, the costs also include the time paid for IT personnel to fix system and configuration errors caused by the users. To combat the rising TCO per computer, companies have implemented new technologies. For example, Microsoft Corporation has implemented Intellimirror® and Group Policy (GP) technologies into its Windows® 2000 operating system.

Policy objects enable administrators to centrally manage configurations of their IT resources that are present and managed through a directory service. One example of a directory service is Active Directory® (AD). AD is Microsoft's current Windows® 2000 directory service that stores information about all objects on the computer network. AD makes this information easily accessible for administrators and users.

Management of Group Policy is important. Group Policy is closely tied to Windows® 2000 Active Directory® (AD). It is the AD service that enables Group Policy. Group Policy Objects (GPOs) store the policy information. These GPOs are linked to selected AD containers: sites, domains, and organizational units. However, while Group Policy is an integral component of AD, it has unique management requirements that are not met as part of the management of Active Directory®.

### SUMMARY

In an aspect, the invention features a method of analyzing group policies in an information management system where the method including monitoring information obtained for a policy repository console, logging the monitored information into a policy editor, analyzing the monitored information via a repository administration.

One or more of the following features may be included. The information management system may include a plurality of individual processing engines coupled together by the distributed interconnect. The information management system may include a content delivery system. The plurality of processing engines may include a system management engine, and wherein the method may include using the system management engine to perform complexity, risk, auditing and internal control, and change. The repository administration may be implemented on a device external to the information management system.

In embodiments, the method may also include dynamically managing system resources based on the results of the analyzing. The method may also include dynamically managing system resources displayed on a graphical user interface.

In another aspect, the invention features a method including, in a network, executing a policy repository process, providing a policy editor process, and executing a repository administrative process.

One or more of the following features may be included. The policy repository process may include maintaining a set of user functionalities, the set including generic policy object operations. The generic policy object operations may include generating a policy object, importing the policy object, editing the policy object, generating directory service links, and modifying directory service links.

The policy object process may include a set of user tools, the user tools including edit policy object functions and check-out policy functions.

The policy editor process may also include displaying object settings in a graphical user interface.

The repository administration process may include restricting tasks and operations for an end user within a security repository, configuring the security repository and security permission for users and groups to the security repository.

The present invention integrates with a directory service through a management console, like Microsoft Management Console (MMC), for importing and exporting policy objects. A console is a set of snap-ins that an operating system treats as an administrator's workspace. An operating system stores each console's details in a Management Saved Console file, which has an .msc extension and which you can distribute and share as you would any other file. When you use an .msc file, you're actually starting up the MMC executable (i.e., mmc.exe) and passing the name of the .msc file as the first parameter in the command line. If you start up mmc.exe without a parameter, you begin with a blank console and can then load the snap-ins you want to work with. Microsoft, for example, provides Win2K with a comprehensive set of consoles. These standard Win2K consoles manage basic elements such as services running on the local computer and local file shares as well as discrete applications such as DNS and Active Directory (AD). Note that some of the AD consoles appear under Programs, Administrative Tools only when the server acts as a domain controller (DC). However, the AD snap-ins are available on all servers, and you can quickly combine these snap-ins into a customized console on any server. Where a console is loaded on a server that isn't a DC, the server will need to connect to a DC before it can access any AD data.

Some objectives of a Group Policy Repository (GPR) solution are to: provide a mechanism to create policy objects offline, provide configuration management for group policies, provide auditing and tracking information on who changed what and when, improve security of the directory service environment by limiting access rights required to manage policy objects, and finer granularity of delegation to manage policy objects.

There are other objectives of the repository solution. For example, an objective is to design offline policy object generation and management in a manner that would enable an organization to later generate and market a policy object management system. Such a system can be licensed to any third party vendor or large corporation interested in extending and managing their policy object infrastructure. Another objective is to develop a policy object repository that has an open architecture that ties into policy management products.

The interaction of GPR with a directory service involves an administration console to prop up the domain browser and object pickers to connect to domains and select user accounts to setup security permissions for repository. Additionally, the repository Console connects to a directory service to select organizational units (OUs), import policy objects and export back to a directory service. Finally, directory service users and computers are extended to have menus for links to repository.

### DESCRIPTION OF DRAWINGS

FIG. 1 is a block diagram of a network.

FIG. 2 is a block diagram of a computer system.

FIG. 3 is a flow diagram of a client tier process.

FIG. 4 is a block diagram of a graphical user interface (GUI).

### DETAILED DESCRIPTION

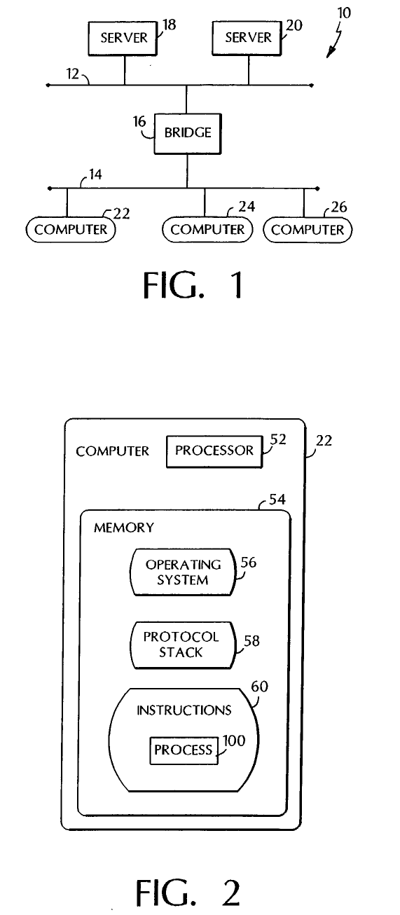

Referring to FIG. 1, an exemplary network 10 includes a local area network (LAN) 12 and a local area network (LAN) 14 linked via a bridge 16. The LAN 12 includes sever systems 18, 20. The LAN 14 includes computer systems 22, 24 and 26.

Referring to FIG. 2, each computer system, computer system 22 for example, includes a processor 52 and a memory 54. Memory 54 stores an operating system (o/s) 56 such as Microsoft Windows® 2000, UNIX or LINUX, a TCP/IP protocol stack 58, and machine-executable instructions 60 executed by processor 52 to perform a client tier policy process 100, described below.

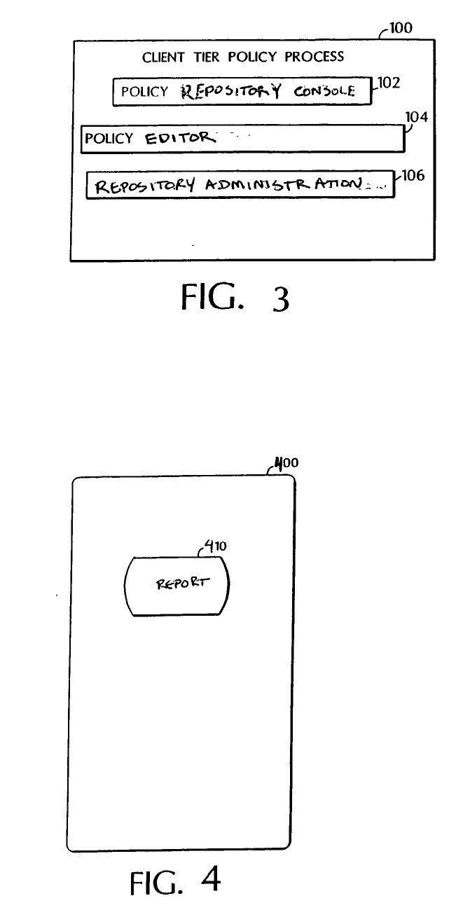

Referring to FIG. 3, the client tier policy process 100 includes a policy repository console process 102, a policy editor process 104, and a repository administration process 106.

Events external to process 100, such as user logon, computer 22 restart, scheduled download or request for manual refresh of policies triggers the process 100.

The Policy Repository Console process 102 includes a set of functionalities with which most users work. The Policy Repository Console process 102 includes generic policy object operations such as Create, Import, Edit, and Create and Modify directory service links.

The Policy Repository Console process 102 includes a number of features. For example, users are able to perform one or many of the following tasks based on the user account permissions they have: add, delete and rename domains and categories; create a policy object; import policy object settings from a directory service or a backed up source of policy object data; checkout a policy object; edit policy object settings; view policy object settings report; create or modify links to OU, create or modify security filters on a policy object; check in a policy object; view the history of policy object versions; generate a report of difference between two versions of a policy object; generate a report of difference between two different policy objects; export policy object settings back to a live directory service or to a backup store; policy object name and property based search; policy setting based search; report on differences between settings of a policy object in the repository and in a live directory service; and configuration management reports (i.e. a repository auditing of which user changed what and when).

The Policy Editor process 104 performs a function of a policy object edit tool that allows users to edit specific settings within a checked out policy object. The Policy Editor process 104 provides an ability to restrict a user to edit only certain sections of the policy object as against the entire policy object and that it will be integrated with the security repository to look like another node in the tree.

The Policy Editor process 104 can display policy object settings as in a policy object editor, have functionality to show only certain sub sections of the policy object based on the security permissions of the user context, explain tab for all policy object settings and not only for a directory service section, display recommended settings, and display links to other relevant settings.

The Repository Administration process 106 is used to secure repository data by restricting tasks and operations that an end user can carry out within the security repository. The Repository Administration process 106 sets up repository and configures security permissions for users and groups who can access the security repository. That is, the repository administration process 106 restricts the generation and deletion of domains and delegates administrative permissions to manage domains. Permissions are set at domain level to generate policy object, edit policy object settings, edit policy object links, edit policy object security filters, view policy object settings, import policy object (which can be a combination of create and edit permissions), and export a policy object to a directory service.

The Repository Administration process 106 is performed through a unified repository console, which is a vehicle for administrating. The administration tasks and property pages are not visible by default. Only administrators enable the “Repository Administration” view and work with additional security settings. This is similar to the “Advanced Features” preference setting in directory service users and computers. Repository and Group Policy Repository both refer to data stores that contain policy objects.

Since security repository operates in a multi user environment, there are concurrency issues if more than one user tries to edit the same policy object. In order to carry out edit operations on a policy object, the user first “checks out” the policy object. When the policy object is in a checked out state, the policy object cannot be checked out or edited by any other user. A policy object cannot be edited unless it has been checked out. A policy object cannot be checked out if it is marked for publishing. An object is so marked when it is ready to be finalized. Each check-out and check-in operation on a policy object increases the security repository version number by 1. After edits are carried out, the policy object is checked-in, in order to make the policy object available for further edits and other operations.

When policy object edits are carried out offline, a user may review the changes. Once the user has approved the change, the status of the policy object is changed to “Publish”. It is only those policy objects that have a “Publish” status that can be exported to a live directory service domain.

Each directory service domain can have multiple policy objects. In order to facilitate the management of these enterprise policy objects in the security repository, related policy objects can be grouped under categories. Within a directory service domain, a policy object can belong to more than one category. Security access to repository policy objects can be controlled at the “Category” level.

Each policy object in the security repository can have multiple versions. Every time a policy object is checked out, edited and checked-in, a new repository version of the policy object is generated. The actual policy object version number (Computer and User) numbers are not changed. The actual policy object version number is incremented by 1 (User or Computer versions) only when the policy object is exported to a directory service. A history functionality in a policy object repository is used to display the information about various versions of a policy object that exist in the security repository.

When a user needs to know what settings have changed between any two versions of a policy object a differencing feature is used. The differencing feature produces a report on the exact settings that are present or absent in the given versions.

A function of security repository is to keep track of which user has changed what setting and when the change was effected. Repository auditing provide these reports. Only policy objects that have a “Publish” status can be exported to a live directory service. Each checkin and checkout task has a “comment” associated with it. For any of the versions of a policy object, users can baseline and mark the object using a label.

The repository user interface has “Repository” as a root node. This root node has the following general properties: location of the security repository, date of creation, date of modification, and creator owner. The repository node would have the following repository security properties: add/remove user accounts, groups and set Allow or Deny when creating or deleting a domain or managing security settings.

Activating the Repository node (e.g., clicking), a right pane displays statistical information about a status and contents of the security repository. The right pane displays information on when the security repository was generated, its location, the number of domains managed and the number of policy objects in each domain. Among the current policy objects, it displays the number of policy objects that have been changed since the last EXPORT, that is, the number of policy objects that are ready to be published. It also displays the number of disjointed policy objects that have currently been checked out.

The domain node has the general properties of domain name and domain controllers. Its repository security properties are to add/Remove user accounts and groups and to set Allow or Deny for several tasks. These tasks include: create a new policy object, import a policy object from a directory service, export a policy object to a directory service, and create categories. On click of the domain node, the right pane should display statistical information about the status and contents of this domain. It has information on the number of policy objects in the domain and the number of checked out policy objects.

Referring to FIG. 4, a Graphical User Interface (GUI) 400 is generated by the process 100. On click of a policy object node, the right pane may display a report 410. This policy object has the following general properties: policy object name, GUID, Created Date and Time, Current policy object Repository version number, and Last Published version. This node may have directory service links that include a list of OUs this policy object is linked to or add/remove OU linkage.

The policy object node has the following policy object security properties: list of users, computers and groups, ability to add/remove users, computers and groups. For each account, the user may specify Allow, Deny on Read, Write, Create/Delete child objects and Apply policy object. The policy object node may also have Repository Security to Add/Remove user accounts and groups and to set Allow or Deny for the following tasks: View History, Rollback policy object settings, Publish policy object, export to a directory service, and edit policy object.

This node has the following tasks: Check Out a policy object, Check in a policy object, Undo Check out, policy object History Operations, Publish a policy object, and Export a policy object to a directory service.

On selection of the policy object History operations property of a policy object node, the user interface details out the history of policy object versions that have been generated and operated upon in the repository. On selecting each version the following three operations may be performed: (a) details have information such as description, comment and label in addition to the version, date and user information; (b) report would launch the complete policy object report in a new window; and (c) rollback sets the contents of the current policy object version (top of the stack)with the contents of the selected policy object version.

The difference operation requires more than one policy object version to be selected. It opens up a new page containing a difference report.

When any policy object needs to be edited, it is checked out first. A checked out policy object is visually indicated in the UI. No other user is able to check this policy object out until this user checks in or does an “Undo check-out” operation.

Once a policy object is successfully checked out, the policy object node expands to open up the contents of the policy object. The Computer and User settings sub nodes are organized in the same format as the policy object editor snap-in. Each of these sections have further sub nodes that may be enabled or disabled based on the user's security permission. On the right pane, settings and their status are displayed. Each of these policy settings can be enabled, disabled, or left not configured.

A publish is a special task carried out that signifies that all the edits to the object have been completed and that the object is ready for export into a directory service. Such “published” policy objects are visually indicated in the user interface. This enables the administrators to easily identify policy objects that need to be exported to a directory service and thus differentiates such policy objects from other policy objects with checked in status. In order to publish a policy object, check in the policy object version and select “Publish” task.

When a policy object is exported to a directory service, it is under one of the following two circumstances: a policy object is not present in a directory service or a policy object already exists in a directory service. Where a policy object is not present, a new policy object is generated, linked and security filters set as it exists in the repository. The policy object version number is set as 1(U)and 1(C) {if both user and machine setting are present} else only the relevant section's version number is updated. Where a policy object already exists, the difference between a live directory service policy object and repository policy object is stored in repository as a report and the policy object version number of a live policy object is read before the update (e.g. 6(C) 4(U)). If a repository policy object is at version 10 and has only computer setting updates then the live policy object version is incremented to 7(C) 4(U).

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

The invention has been described in terms of particular embodiments. Other embodiments are within the scope of the following claims.

What is claimed is:

1. A method of analyzing group policies in an information management system where said method comprises:
(a) monitoring information obtained for a policy repository console;
(b) logging said monitored information into a policy editor; and
(c) analyzing said monitored information via a repository administration.

2. The method of claim 1, wherein said information management system comprises a plurality of individual processing engines coupled together by said distributed interconnect.

3. The method of claim 2, wherein said information management system comprises a content delivery system.

4. The method of claim 2, wherein said plurality of processing engines comprise a system management engine; and wherein said method comprises using said system management engine to perform complexity, risk, auditing and internal control, and change.

5. The method of claim 1, wherein said repository administration is implemented on a device external to said information management system.

6. The method of claim 1, wherein said method further comprises dynamically managing system resources based on the results of said analyzing.

7. The method of claim 6, wherein said method further comprises dynamically managing system resources displayed on a graphical user interface.

8. A method comprising:
a network, executing a policy repository process;
providing a policy editor process; and
executing a repository administrative process.

9. The method of claim 8 in which the policy repository process comprises:
maintaining a set of user functionalities, the set including generic policy object operations.

10. The method of claim 9 in which the generic policy object operations comprise:
generating a policy object;
importing the policy object;
editing the policy object;
generating directory service links, and
modifying directory service links.

11. The method of claim 8 in which the policy object process comprises a set of user tools, the user tools including edit policy object functions and check-out policy functions.

12. The method of claim 8 in which the policy editor process comprises:
displaying object settings in a graphical user interface.

13. The method of claim 8 in which the repository administration process comprises:
restricting tasks and operations for an end user within a security repository;
configuring the security repository and security permission for users and groups to the security repository.

14. A computer program product stored on a computer readable medium, for maintaining group policies in an information management system, comprising instructions to cause a programmable processor to:
execute a policy repository process;
provide a policy editor process; and
execute a repository administration process.
